(19) United States
(12) Patent Application Publication
(10) Pub. No.: US 2010/0221528 A1
(43) Pub. Date: Sep. 2, 2010

(54) Extrusion coated article

(76) Inventors: Thomas J. Schwab, Loveland, OH (US); R. Scott Weber, Liberty Township, OH (US); Richard T. Sylvester, Liberty Township, OH (US)

Correspondence Address: LyondellBasell Industries, 3801 WEST CHESTER PIKE, NEWTOWN SQUARE, PA, 19073, US

(21) Appl. No.: 12/380,455

(22) Filed: Feb. 27, 2009

(51) Int. Cl. B32B 27/32; B05D 3/12

(52) U.S. Cl. 428/336; 427/359

(57) ABSTRACT

An extrusion coated article and process to extrusion coat a substrate are disclosed. A blend of LDPE having a MI₂ greater than 5 dg/min and m-LLDPE having a MI₂ less than 5 dg/min and, by differential scanning calorimetry, at least two melting points is used. Suitable substrates include paper, cardboard, metallized film, and metal foil. The polyolefin layer has a thickness within the range of 2 to 12 microns. A good combination of drawdown, seal strength, and hot tack strength is obtained.

### FIELD OF THE INVENTION

This invention relates to an extrusion coated article with a polyolefin layer coated on a substrate. The polyolefin layer comprises a blend of LDPE and m-LLDPE.

### BACKGROUND OF THE INVENTION

An extrusion coating process is used to apply a thin layer of polymer to a substrate such as paper or metal foil to provide certain properties such as heat-seal ability, puncture resistance, and tear strength. Low density polyethylene (LDPE) is commonly used because of its ease of processability, physical properties, and relatively low cost. However, additional improvements are needed especially regarding drawdown (ability to apply a thin coating) while maintaining physical properties. To improve drawdown, LDPE with a higher melt index has been used but this causes a loss in properties such as hot tack strength and seal strength.

There has been some work done with polyethylene blends. U.S. Pat. No. 4,339,507, for example, discloses linear low density polyethylene (LLDPE) and LDPE blends for extrusion coating. Papers coated with blends containing 75-85% LLDPE were heat sealed but there is no disclosure of seal strength or hot tack strength. There is no disclosure of metallocene LLDPE (m-LLDPE). Differential scanning calorimetry results are not disclosed, but LLDPE prepared by the disclosed procedures has one melting point.

U.S. Pat. No. 5,376,439 discloses films prepared from blends of low to medium density polyethylene, including LDPE, with very low density polyethylene (VLDPE) prepared with metallocene catalysts. The VLDPE has an “essentially single melting point characteristic.” Film thickness is in the range of from about 0.5 to about 2 mil (12.7 to 50.8 microns), preferably from about 0.75 to 1.5 mil (19 to 38 microns). ABA laminar films are also disclosed where A represents the blend. No extrusion coating is disclosed. There is no disclosure of properties important in extrusion coating such as drawdown, hot tack strength, and seal strength.

U.S. Pat. No. 5,395,471 discloses a process for extrusion coating a substrate with a thermoplastic composition. The thermoplastic composition contains from 0 to 90% by weight of a polymer selected from Ziegler-Natta linear ethylene polymer and LDPE and 10 to 100% by weight of a substantially linear ethylene polymer having specific rheological and molecular weight distribution requirements and preferably made by constrained geometry single-site catalysts. The substantially linear ethylene polymer has a density from 0.85 to 0.96 g/cm³ and a single melting point.

The effect of blend components on properties such as drawdown, hot tack strength, and seal strength is not well understood, but it is possible that the broad molecular weight distribution and non-uniform comonomer incorporation of Ziegler-Natta catalyzed LLDPE enables an improved combination of properties. However, this broad molecular weight distribution and uneven comonomer incorporation can also contribute to wax byproducts that increase manufacturing costs and complexity.

Despite considerable research, compromises are still made between processability and physical properties. It would be useful if such improvements could be attained

### SUMMARY OF THE INVENTION

In one aspect, the invention is an extrusion coated article. A polyolefin layer is coated on a substrate. The polyolefin layer has a thickness within the range of 2 to 12 microns and comprises a blend of a low density polyethylene (LDPE) and a single-site based linear low density polyethylene (m-LLDPE) having at least two melting points. The invention also includes a multilayer article with a substrate, an inner polymer layer, and an outer polyolefin layer. Also included is an extrusion coating process.

### DETAILED DESCRIPTION OF THE INVENTION

The invention relates to extrusion coated articles. Extrusion coating generally involves heating a polymer to a temperature above its melting point, extruding it through a flat die onto a substrate which passes through the curtain of molten polymer, subjecting the coated substrate to pressure to create adhesion, and then cooling. The coating thickness can be influenced by various factors including the extrusion conditions, the rheological properties of the polymer, and the speed that the substrate passes through the curtain. Preferably, the coating is applied as thinly as possible while maintaining properties. A convenient measure of coating thickness is pounds (lbs.) per ream. A ream is 3,000 ft². Drawdown is a measure of how thin the molten polymer can be drawn before breaking. Drawdown can be determined by coating a substrate at a certain coat weight and decreasing the coat weight until the coating becomes imperfect due to either instability of the melt curtain or variability of the coating, especially at the edges. In extrusion coating, depending upon the material and the coating conditions, the coating can be thicker at the edge of the substrate. This is called edge bead. Edge bead is commonly caused when the ratio of the speed that the substrate is moving increases relative to the speed that the extrudate exits the die. The drawdown value is the minimum coat weight that provides a uniform coating. Preferably, the drawdown is less than 7 lbs. per ream.

Extrusion coated articles of the invention comprise a substrate and a polyolefin layer coated on the substrate. The substrate can be a film, sheet, or article and can be paper, cardboard, paperboard, plastic film, metallized film, or metal foil. The metal or metal foil can be any metal. Suitable metals include iron, steel, copper, and aluminum. Preferably, the substrate is flat and is paper, cardboard, or metal foil.

The polyolefin layer has a thickness within the range of 2 to 12 microns. The layer comprises a blend comprising a low density polyethylene (LDPE) and a single-site based linear low density polyethylene (m-LLDPE). The blend comprises 60-90% by weight of LDPE. Typically, LDPE is prepared by a high temperature, high pressure process and is considered to proceed by a free radical mechanism. The LDPE has a melt index (MI₂) of greater than 5 dg/min as measured according to ASTM D1238, Condition 190/2.16.

The blend further comprises 10-40% by weight of a single-site based linear low density polyethylene, m-LLDPE. By “single-site,” we mean catalysts that have a uniform kind of catalytic site, including both metallocene and post-metallocene catalysts, but excluding catalysts having multiple, different catalytic sites such as Ziegler-Natta catalysts and chromium Phillips-type catalysts. Preferably, the catalyst comprises an activator and an organometallic complex, wherein the organometallic complex comprises a Group 3 to 10 transition metal and at least one polymerization-stable anionic ligand bonded to the transition metal. Suitable m-LLDPE includes, for example, Exceed™ and Enable™ m-PE grades available from ExxonMobil Chemical and Affinity™ polyolefin plastomers from Dow Chemical. m-LLDPE used in the inventive blends has a melt index of less than 5 dg/min as measured according to ASTM D1238, Condition 190/2.16.

By differential scanning calorimetry (DSC), the m-LLDPE has at least two melting points. This feature is believed to impart good heat-seal ability to the polymer blend. The number of DSC melting points can be tested by first melting a sample to remove any thermal history and then cooling at a uniform rate. The sample is then heated at a controlled rate and thermal events are observed. A melting point is indicated by an endotherm. If a sample has a single melting point, a single endotherm is observed. Multiple endotherms indicate multiple melting points. Preferably, the blend comprises 20-40% by weight of a m-LLDPE.

Preferably, the extrusion coated article has a good seal strength and good hot tack strength. One valuable use for the coated articles is in packaging. After a package has its contents, it is sealed, typically at elevated temperatures. Seal strength measures the force required to pull apart the seal. High seal strength can allow increased package integrity, particularly if the packaged product is a fine powder, which can interfere with making a good seal. Seal strength can be measured according to ASTM D 882/F88. When sealed at 110° C. and tested at room temperature, the seal strength is preferably greater than 3.0 lbs. Hot tack strength is a measure of the strength of the seal at elevated temperatures. When the package is first sealed, it is still hot and can be susceptible to forces that can pull the seal apart. The hot tack strength can be measured according to ASTM F1921. Preferably, the hot tack strength at 110° C. is greater than 0.4 lbs., more preferably greater than 0.7 lbs. Preferably, the hot tack strength at 100° C. is greater than 0.7 lbs., more preferably, greater than 0.8 lbs.

In another aspect, the invention is a multilayer article comprising a substrate, an inner polymer layer, and an outer polyolefin layer wherein the inner and outer layers are coextruded on the substrate. The substrate and polyolefin layer are as described for the extrusion coated article. The inner polymer layer can be any polymer or polymer blend such as polypropylene, polyethylene, anhydride-grafted polyolefin, nylon, or acrylonitrile-butadiene-styrene (ABS) copolymer. Preferably, the polymer imparts certain properties to the multilayer article, such as improved stiffness, improved barrier properties, or improved adhesion. Preferably, the polymer is a polyolefin or grafted polyolefin.

In another aspect, the invention is a process to produce an extrusion coated article. A blend comprising from 60 to 90 wt. % of a LDPE and from 10 to 40 wt. % of a m-LLDPE is prepared and fed to an extruder. The LDPE has a MI₂ greater than 5 dg/min. The m-LLDPE has a MI₂ less than 5 dg/min and, by DSC, at least two melting points. The extrudate is applied to a substrate. The extrudate can be applied as an extruded film or optionally, as a blown film. Preferably, the substrate is a moving, flat substrate such as paper, paperboard, metal foil, or plastic film. The coated substrate then usually passes between a set of counter-rotating rolls that press the coating onto the substrate to ensure complete contact and adhesion. The coating thickness is 2 to 12 microns thick. The thickness can be controlled by varying the extruder conditions, the rate that the blend is fed to the extruder, or the speed of the moving substrate. Preferably, the substrate travels though the melt curtain at a speed of greater than 300 feet per minute.

The following examples merely illustrate the invention. Those skilled in the art will recognize many variations that are within the spirit of the invention and scope of the claims.

### EXAMPLE 1

A dry blend of 70% by weight LDPE and 30% by weight m-LLDPE is prepared. The LDPE is prepared by a high-temperature, radical process and has MI₂=10 dg/min as measured according to ASTM D1238, Condition 190/2.16; density=0.918 g/cm³ measured according to ASTM D-1505-96; and is available from Equistar Chemicals, LP as NA214000.

The m-LLDPE is a hexene-based ethylene copolymer prepared with a metallocene catalyst and has MI₂=3.5 dg/min; density=0.912 g/cm³; and is available from ExxonMobil Corporation as Exceed 3512CB. A 2.44-mg sample of the m-LLDPE is tested by DSC by heating the sample to 160° C. at 10° C. per minute, holding for 5 minutes, cooling to 0° C. at 10° C. per minute, and scanning as the temperature is increased to 160° C. at 10° C. per minute. The m-LLDPE exhibits multiple melting points, a pronounced endotherm with a maximum at 101° C., a pronounced endotherm with a maximum at 113° C., and a shoulder endotherm with a maximum at 117° C.

The blend has MI₂=7.3 dg/min; density=0.916 g/cm³. The blend is extruded at a melt temperature of 330° C. on a single-screw extruder with a web width of 30 inches, and the extrudate is applied on Kraft paper moving at 500 feet per minute. The coat weight is initially 14 lbs. per ream and the “neck-in” (defined as the difference between the width of the die and the final coating width, measured at drawdown=14 lbs./ream) is 3.6 inches. The coated paper is passed through a set of counter-rotating rolls to ensure complete contact. The feed rate of the blend to the extruder is gradually decreased to observe the stability of the melt curtain and control of edge bead. The coating is uniform down to a coat weight of 3 lbs. per ream (i.e., the drawdown=3 lbs. per ream). The coating thickness is 5 microns. The coated paper is sealed at 110° C. and allowed to cool to room temperature. Seal strength (by ASTM D882/F88) is 3.4 lbs. Hot tack strength (ASTM F1921) is 0.83 lbs. at 110° C. and 0.88 lbs. at 100° C.

### EXAMPLE 2

A dry blend of 85% by weight LDPE and 15% by weight m-LLDPE is prepared. The LDPE is the same as used in Example 1. The m-LLDPE is a hexene-based ethylene copolymer prepared with a metallocene catalyst and has MI₂=1.0 dg/min; density=0.912 g/cm³; and is available from ExxonMobil Corporation as Exceed® 1012CA. The m-LLDPE exhibits multiple melting points, a pronounced endotherm with a maximum at 103° C., a pronounced endotherm with a maximum at 115° C., and a shoulder endotherm with a maximum at 119° C. The blend has MI₂=7.1 dg/min; density=0.917 g/cm³. The blend is extruded and the extrudate applied on Kraft paper as in Example 1. Drawdown=5-6 lbs. per ream. Coating thickness: 10 microns. The results are reported in Table 1.

### COMPARATIVE EXAMPLE 3

A dry blend of 85% by weight LDPE and 15% by weight LLDPE is prepared. The LDPE is the same as used in Example 1. The LLDPE is a butene-based ethylene copolymer prepared with a Ziegler-Natta catalyst and has MI₂=1.0 dg/min; density=0.918 g/cm³; and is available from Equistar Chemicals, LP as Petrothene® GA501020. The LLDPE exhibits a single melting point, a sharp endotherm with a maximum at 121° C. The blend has MI₂=7.1 dg/min; density=0.918 g/cm³. The blend is extruded and the extrudate applied on Kraft paper as in Example 1. Drawdown: 7-8 lbs. per ream. Coating thickness: 13 microns. The results are reported in Table 1.

### COMPARATIVE EXAMPLE 4

A dry blend of 85% by weight LDPE and 15% by weight LLDPE is prepared. The LDPE is the same as used in Example 1. The LLDPE is a hexene-based ethylene copolymer prepared with a Ziegler-Natta catalyst and has MI₂=1.0 dg/min; density=0.918 g/cm³; and is available from Equistar Chemicals, LP as Petrothene® GA601030. The LLDPE exhibits a single melting point, a sharp endotherm with a maximum at 123° C. The blend has MI₂=7.1 dg/min; density=0.918 g/cm³. The blend is extruded and the extrudate applied on Kraft paper as in Example 1. Drawdown: 3-4 lbs. per ream. Coating thickness: 6 microns. The results are reported in Table 1.

### COMPARATIVE EXAMPLE 5

LDPE as used in Example 1 and with no LLDPE is extruded and the extrudate applied on Kraft paper as in Example 1. Drawdown: 10 lbs. per ream. Coating thickness: 18 microns. The results are reported in Table 1.

TABLE 1
Coated Paper

| | | | | | Hot tack |
|---|---|---|---|---|---|
| | | Neck-in | Coating | Seal | strength |
| | Drawdown | (inches at | thickness | Strength | (lbs. at |
| Example | (lbs./ream) | 14 lbs./ream) | (microns) | (lbs.) | 100° C.) |
| 1 | 3 | 3.6 | 5 | 3.4 | 0.88 |
| 2 | 5-6 | 3.1 | 10 | 3.3 | 0.85 |
| C3 | 7-8 | 3.1 | 13 | 2.9 | 0.94 |
| C4 | 3-4 | 3.1 | 6 | 3.4 | 0.70 |
| C5 | 10 | 1.9 | 18 | 2.9 | 0.92 |

The results in Table 1 show that Examples 1 and 2, using LDPE with a m-LLDPE having a MI₂ less than 5 and more than one melting point, enable lower drawdown and improved seal strength versus LDPE without the m-LLDPE (Comparative Example 5). The improvements rival or exceed those seen with Ziegler-Natta LLDPE (Comparative Examples 3 and 4). Example 1, which uses 30% of m-LLDPE having a MI₂=1.0, gives a superior combination of low drawdown, high seal strength, and good hot tack strength.

The preceding examples are meant only as illustrations. The following claims define the invention.

We claim:

1. An extrusion coated article comprising a substrate and a polyolefin layer coated on the substrate, wherein the polyolefin layer has a thickness within the range of 2 to 12 microns and comprises a blend comprising: (a) from 60 to 90 wt. % of a low density polyethylene (LDPE) having a MI₂ greater than 5 dg/min; and (b) from 10 to 40 wt. % of a single-site based linear low density polyethylene (m-LLDPE) having a MI₂ less than 5 dg/min and, by differential scanning calorimetry (DSC), at least two melting points.

2. The article of claim 1 having a seal strength, measured according to ASTM D882/F88, greater than 3.0 lbs. when sealed at 110° C. and tested at room temperature.

3. The article of claim 1 having a coat weight of less than 7 lbs./ream.

4. The article of claim 1 having a hot tack strength at 110° C., as measured by ASTM F1921, of greater than 0.7 lbs.

5. The article of claim 1 wherein the substrate is selected from the group consisting of paper, cardboard, metallized film, and metal foil.

6. The article of claim 1 wherein the m-LLDPE is a copolymer of ethylene with a C₆-C₁₂ α-olefin.

7. The article of claim 1 wherein the m-LLDPE has a density from 0.910 to 0.925 g/cm³.

8. A multilayer article comprising a substrate, an inner polymer layer, and an outer polyolefin layer wherein the inner and outer layers are coextruded on the substrate and wherein the outer polyolefin layer has a thickness within the range of 2 to 12 microns and comprises a blend comprising: (a) from 60 to 90 wt. % of a LDPE having a MI₂ greater than 5 dg/min; and (b) from 10 to 40 wt. % of a m-LLDPE having a MI₂ less than 5 dg/min and, by DSC, at least two melting points.

9. A process which comprises extrusion coating a substrate with a molten polyolefin layer to produce the article of claim 1.

10. A process which comprises coextruding onto a substrate a coating comprising a molten inner polymer layer and a molten outer polyolefin layer to produce the multilayer article of claim 8.
